(19) United States
(12) Patent Application Publication
(10) Pub. No.: US 2014/0056684 A1
(43) Pub. Date: Feb. 27, 2014

(54) DENESTING APPARATUS AND METHOD

(71) Applicant: Christopher M. SYDORKO, Red Lion, PA (US)

(72) Inventor: Christopher M. SYDORKO, Red Lion, PA (US)

(21) Appl. No.: 13/595,235

(22) Filed: Aug. 27, 2012

(51) Int. Cl. B65G 59/10

(52) U.S. Cl. 414/795.6

(57) ABSTRACT

A tray denesting apparatus presents stacks of trays placed upside down within a storage area to a picker mechanism, and separates single trays from the stack of trays. Pneumatically and electrically controlled actuators are employed for handling of the stacked trays. A pneumatic separating device or suction pad may be used to remove individual trays from the tray stack. The Bernoulli principle operates by generating a differential pressure to draw in the tray in a materials handling system. Differential pressure is generated by transporting air through one or more passages in the suction pad to decrease pressure in a chamber. The decreased pressure draws the object towards the pad. After picking up the individual tray a driven rotary device inverts the tray and places the tray onto a tray conveyor located beneath the denesting apparatus.

### BACKGROUND

The application generally relates to a tray denesting apparatus. The application relates more specifically to an apparatus for automatic denesting or separation of stacked trays used for storage and shipping of food items.

During packaging operations, products may be placed in trays and further processed downstream from the packaging machine. Product trays are typically made of Styrofoam® or similar material. The trays are shipped and stored in nested stacks in which each of the trays conform to and are placed in contact with one another for shipping and handling. During the packaging process each tray must be separated individually from the adjacent tray of the stack prior to filling the tray with a product. Different types of mechanical assemblies have been developed to separate individual trays from a stack of trays for packaging. It is desirable that a tray denester be able to quickly and reliably separate trays from a stack to increase the packaging throughput of a facility.

Current available tray denesters are arranged to present trays to a conveyor system so that the tray is facing upward, in a position to receive product for wrapping. This means that the stacks of trays are placed in the current systems with the useable side facing up. As a result debris, e.g., Styrofoam material from the trays, may collect within the usable area of the tray. Further, such an arrangement does not allow the system to position the trays using the top side of the upper lips on the trays.

Currently tray denesters are configured to separate trays by either capturing the bottom side of the upper lips using a rotary screw conveyor mechanism, or by capturing the bottom of the upper lip using a pivoting rod mechanism. These existing methods are unreliable for denesting most Styrofoam trays because the thickness of the tray lip is not maintained at close tolerances during manufacturing. As a result, the separation mechanism may fail to separate the trays consistently. This does not permit consistent separation location regardless of Styrofoam manufacturing inconsistencies.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

A tray denesting apparatus, presents stacks of trays placed upside down within a storage area to a picker head mechanism, and separates single trays from the stack of trays. Pneumatically and electrically controlled actuators and slides are employed for handling of the stacked trays. A pneumatic separating device, e.g., a Bernoulli Effect suction pad, may be used to pick and remove individual trays from the tray stack. The Bernoulli principle operates by generating a differential pressure to draw in an object, e.g., a tray, in a materials handling system. The differential pressure can be generated by transporting air through one or more passages in the suction pad to decrease pressure in a chamber. The decreased pressure in the chamber pulls the object towards the pad. After picking up the individual tray an electrically driven rotary device inverts the tray places the tray onto a tray conveyor located beneath the denesting apparatus.

One embodiment relates to an apparatus for automatically positioning trays from a nested stack of trays onto a conveyor includes a tray denester system. The tray denester system includes a stack holder for holding at least one nested stack of trays. The stack holder includes a column wherein the stack holder maintains the nested stack of trays in a face down alignment and biased towards a bottom end of the column. Separation elements are disposed adjacent a bottom end of the stack holder. The separation elements are operable to separate a bottom tray from the nested stack of trays. Pins are disposed beneath the bottom tray and are operable to controllably release the bottom tray. A rotary inverter unit is disposed below the tray denester system. The rotary inverter unit includes suction elements and a drive system arranged to position one of the suction elements at a time below the tray denester system and to receive the bottom tray released from the tray denester. The rotary inverter rotates the received tray to an inverted position and releases the received tray in an inverted position to a conveyor in a face up alignment.

Another embodiment relates to an apparatus for inverting trays for positioning onto a conveyor includes suction elements and a drive system. The drive system position the suction element below a tray denester system to receive a bottom tray released from the tray denester and rotates the received tray to an inverted position. A suction element of the apparatus releases the received tray in an inverted position to a conveyor in a face up alignment.

Still another embodiment relates to a tray handling system which includes a tray denester system, a rotary inverter and a conveyor. The tray denester system positioned above the rotary inverter for iteratively discharging a single tray from a nested stack of trays. The rotary inverter is positioned to receive the single tray, invert and discharge the single tray to the conveyor. The rotary inverter is positioned above the conveyor. The tray denester system including a stack holder for holding at least one nested stack of trays. The stack holder includes a column wherein the stack holder maintains the nested stack of trays in a face down alignment and biased towards a bottom end of the column. Separation elements are disposed adjacent a bottom end of the stack holder. The separation elements are operable to separate a bottom tray from the nested stack of trays. Pins are disposed beneath the bottom tray and are operable to controllably release the bottom tray. The rotary inverter unit disposed below the tray denester system. The rotary inverter unit is disposed below the tray denester system. The rotary inverter unit includes suction elements and a drive system arranged to position one of the suction elements at a time below the tray denester system and to receive the bottom tray released from the tray denester. The rotary inverter rotates the received tray to an inverted position and releases the received tray in an inverted position to a conveyor in a face up alignment. The conveyor is operable to receive a plurality of the received trays one at a time and transport the received tray away from the rotary inverter.

Certain advantages of the embodiments described herein include the stacks are presented inverted—i.e., with the usable topside facing downward—so that the denester may utilizes the fixture topside of the tray and mechanically separate trays with pneumatic cylinders and wedge blocks at a position relative to the fixture inverted top edge.

Alternative exemplary embodiments relate to other features and combinations of features as may be generally recited in the claims.

### BRIEF DESCRIPTION OF THE FIGURES

FIG. 1 is a tray stack holder for holding a stack of trays with the top surface facing down.

FIG. 2 is a rotary inverter unit configured for inverting and transferring trays to a conveyor underneath the rotary inverter.

FIG. 3 is a general arrangement of the tray stack holder, inverter unit and conveyor.

### DETAILED DESCRIPTION OF THE EXEMPLARY EMBODIMENTS

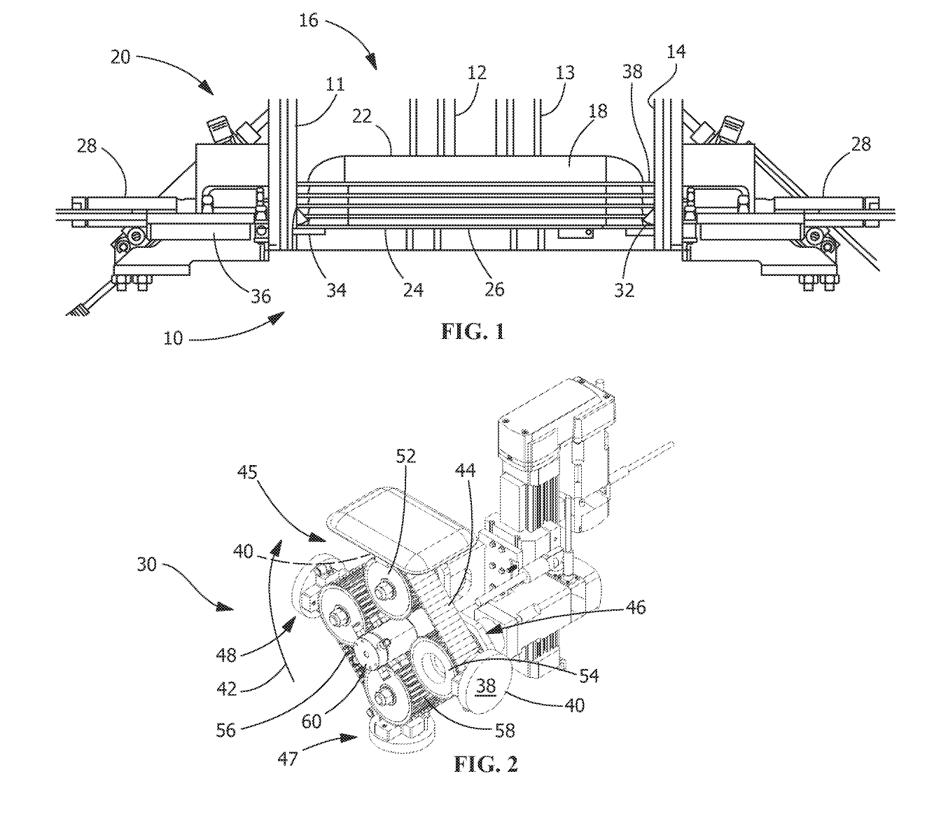

Referring to FIG. 1 a denester system 10 includes a stack holder 20 and a rotary inverter unit 30 (FIG. 2). Stack holder 20 includes vertical guide members 11, 12, 13, 14 defining a column 16 for placement of stacked individual trays 18 for transferring trays 18 to a conveyor belt for further handling. Guide members 11, 14 provide forward and lateral position limits for trays 18, and guide members 12, 13 provide rear position limits for trays 18. Additional vertical guide members may be included if desired for providing further positioning limits, as will be readily appreciated by persons skilled in the art. Trays 18 are typically composed of extruded polystyrene foam material, or Styrofoam®, although other trays composed of other material may be used in denester system 10. Multiple trays 18 may be stacked inverted in column 16. The denester system has stacked trays 18 presented to the system inverted, i.e., the usable side of tray 18 facing downward and the underside 22 facing upward. The inverted stacking arrangement provides advantages over the prior art denester systems. Styrofoam® debris that becomes dislodged, e.g., from the stacked trays, does not collect within the usable area of the tray; and trays 18 may be fixtured using the top side of the upper lip or peripheral edge 24. Accordingly trays 18 may be separated in their inverted position.

Prior art tray denesters are configured to separate trays either by capturing the bottom side of the upper lip of the trays using a screw mechanism, or by capturing the bottom of the upper lip using a pivoting rod mechanism. Both methods are unreliable as the thickness of tray lips is not maintained at high tolerances during the tray manufacturing process. As a result, a separation mechanism may fail to separate the trays consistently.

Denester system 10, with stacked trays 18 presented in an inverted position utilizes the fixture topside 26 of tray 18 to mechanically separate adjacent trays through the operation of cylinders 28 connected to separation elements, e.g., wedge blocks 32 at opposing sides of stack holder 20. In one embodiment cylinders 28 may be pneumatically operated, although alternate embodiments may include hydraulic and electrically operated linear displacement actuators. Trays 18 are biased towards a bottom end of column 16. Wedge blocks 32 are positioned adjacent to the fixture or tray inverted top edge 24. Wedge blocks 32 inserted between top edges 24 of adjacent trays 18 provide consistent separation location regardless of dimensional inconsistencies due to the manufacturing of the trays. Pins 34 on opposing sides of stacked trays 18 are retracted to release a single tray at a time. Cylinders 36 control movement of pins 34 for releasing trays 18. After releasing a tray pins are returned to the extended position to retain the trays stack in position for releasing the next tray. Pneumatic cylinders 28 retract wedge blocks 32 to lower the stack of trays 18. When wedge blocks are in the retracted position, the stack descends and is positioned against pins 34. Pneumatic cylinders 28 then extend wedge blocks 32 into the space between peripheral edges 24 of the lowest two adjacent trays 18, to separate the bottom two trays and allow the lowest tray 18 to release during the next cycle.

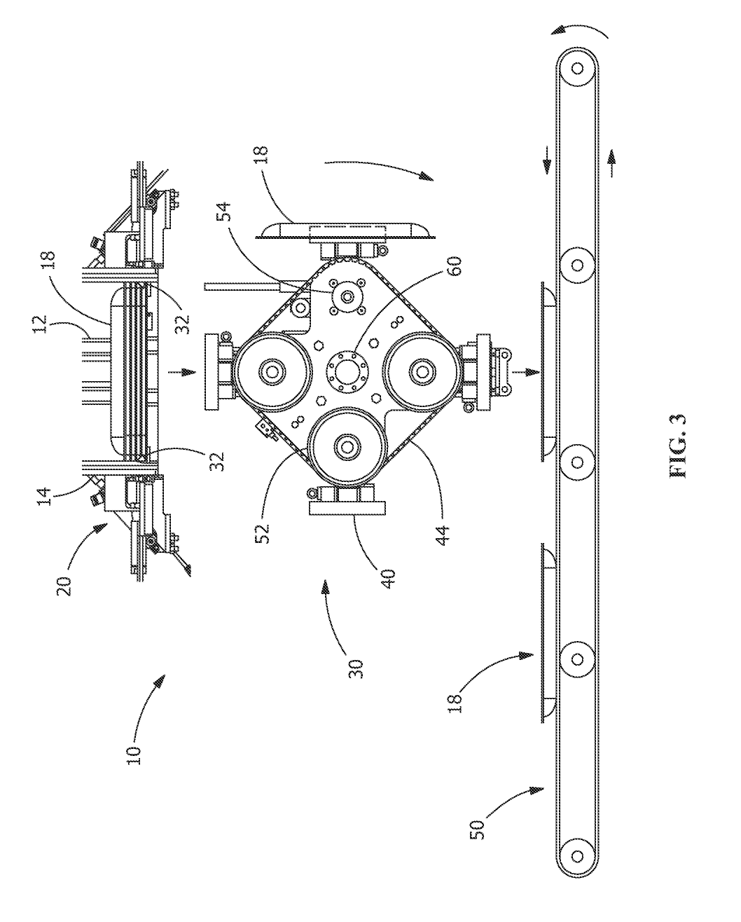

Referring next to FIG. 2, a rotary inverter unit 30 is disposed beneath stack holder 20 and above a conveyor unit 50 (FIG. 3). Inverter unit 30 removes trays 18 with the tray topside facing down as they are released from stack holder 20, and places trays 18 on the conveyor unit 50 with the tray topside facing up. Trays 18 are removed from stack holder 20 using a Bernoulli-style suction pad 40. Inverter unit 30 rotates four suction pads 40 to four different positions. In alternate embodiments more or less suction pads may be employed on inverter unit 30. The use of a Bernoulli style suction pad allows for the separated tray to be pulled from the stack during separation without having to contact the trays.

Inverter unit 30 includes four suction pads 40 attached to and driven by a drive system, e.g., a drive belt 44 in an endless loop. Suction pads 40 may be spaced approximately equidistantly along an exterior side of drive belt 44 and are advanced by drive belt 44 between four positions 45, 46, 47 and 48. At first position 45 suction pad is positioned with the tray receiving surface 38 facing stack holder 20. Drive belt 44 advances suction pads in one direction, which direction is indicated by arrow 42. Drive belt 44 in the exemplary embodiment is a toothed belt that meshes with splines on three idler rollers 52 and a drive roller 54. Drive roller 54 may be, e.g., a servo-motor driven pulley. Teeth 56 and splines 58 provide traction from rollers 52, 54 for moving belt 44. Other belt drive arrangements may be substituted for the toothed belt, including tensioned belts, chain- and wire mesh-driven belts or other power transmission arrangements within the scope of the appended claims. From the first position 45, belt 44 advances suction pad 40 from first position 45 to a second position 46, rotating tray 18 90° to a vertical position in which tray 18 is maintained via suction air. From second position pad 40 is next advanced to the third position 47 by drive belt 44, which causes tray 18 to be rotated an additional 90° to the inverted, or upward facing direction. In third position 47 suction pad tray receiving surface 38 is facing downward, i.e., the direction opposite that of first position 45.

At third position 47, suction pad 40 is controlled by a pneumatic controller 60 to release tray 18 by removing air flow that creates the Bernoulli suction effect. In one embodiment controller 60 may be a pneumatic quad path rotary union which distributes the air to suction pads 40. Each port (not shown) is operated independently through individual solenoid values located remotely. Rotary unions provide a rotating connection feeding pressure to fixtures while allowing full rotation of the union with or without pressure. A machine or independent indexer may be used to accomplish the position indexing. When tray 18 is released at third position 47, tray 18 falls onto a moving conveyor 50 (FIG. 3). Suction pad 40 then advances to the fourth position 48, and in fourth position pad 40 is empty. Thus each suction pad 40 may be moved in sequence through 90° of rotation at each of four positions, i.e., picking a tray 18 from stack holder 20 at first position 45, holding the tray in a vertical position at second position 46, releasing the inverted tray at third position 47, and waiting in fourth position 48 without a tray.

In one embodiment, all four suction pads 40 perform operations simultaneously in sequence at their respective positions, e.g. one pad 40 is picking a tray when positioned at first position 45, while the adjacent pad 40 is holding a tray at second position 46, the next adjacent pad is releasing a tray at third position 47, and the fourth pad 40 is idling without a tray at fourth position. In alternate embodiments, the inverter unit 30 may be modified to perform inversion of trays with only one pad 40 advancing through each of the four positions, or with two pads 40 positioned at 180° and advancing through each of the four positions.

It should be understood that the application is not limited to the details or methodology set forth in the following description or illustrated in the figures. It should also be understood that the phraseology and terminology employed herein is for the purpose of description only and should not be regarded as limiting.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the tray denesting apparatus as shown in the various exemplary embodiments is illustrative only. Although only a few embodiments have been described in detail in this disclosure, those who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. An apparatus for automatically positioning trays from a nested stack of trays onto a conveyor, comprising:
a tray denester system including a stack holder for holding at least one nested stack of trays, the stack holder comprising a column wherein the stack holder maintains the nested stack of trays in a face down alignment and biased towards a bottom end of the column; a plurality of separation elements disposed adjacent a bottom end of the stack holder, the separation elements operable to separate a bottom tray from the nested stack of trays; a plurality of pins disposed beneath the bottom tray, the pins operable to controllably release the bottom tray; and
a rotary inverter unit disposed below the tray denester system, the rotary inverter unit comprising:
at least one suction element comprising a tray receiving surface;
and a drive system configured to position the at least one suction element below the tray denester system and to receive the bottom tray released from the tray denester and rotate the received tray to an inverted position, and release the received tray in an inverted position to a conveyor in a face up alignment.

2. The apparatus of claim 1, wherein the separation elements are positioned adjacent to a top edge of the inverted bottom tray.

3. The apparatus of claim 1, further comprising a pair of pins disposed on opposing sides of the stack of trays, the pins retractable to release the bottom tray of the stack of trays.

4. The apparatus of claim 3, further comprising a first pair of cylinders operably connected to the respective pins, such that the first pair of cylinders in a retracted position retracts the pin to release the bottom tray, and in an extended position extends the pin to retain the stack of trays in position for releasing an adjacent tray.

5. The apparatus of claim 4, further comprising a second pair of cylinders operably connected to the separation elements, the second pair of cylinders retractable to retract separation elements, and extendable to extend the separation elements; such that when the second pair of cylinders and separation elements are in the retracted position, the stack descends and is positioned against the pins; and when extended the second pair of cylinders extend the separation elements into a space between a peripheral edge of each of the lowest two trays in the stack of trays to separate a bottom tray from the nested stack of trays and allow the bottom tray to release during a subsequent cycle.

6. The apparatus of claim 3, further comprising a first pair of cylinders configured to control movement of the pins for releasing trays, wherein after releasing a tray the pins are returned to an extended position to retain the trays stack in position for releasing an adjacent tray.

7. The apparatus of claim 6, further comprising a second pair of cylinders configured to retract separation elements to lower the stack of trays when in the retracted position, such that the stack of trays descends and is positioned against the pins; and wherein the second pair of cylinders extend separation elements into the space between peripheral edges of the lowest two adjacent trays to position the separation elements between the two lowest trays in the stack of trays to allow the lowest tray to release from the stack of trays during a subsequent operation cycle.

8. The apparatus of claim 1, wherein the at least one suction element comprises four suction elements attached to and driven by a drive belt in an endless loop.

9. The apparatus of claim 8, wherein the suction elements are spaced approximately equidistantly along an exterior side of drive belt, the suction elements being advanced by drive belt between four predetermined positions.

10. The apparatus of claim 9, wherein one suction element is disposed with the tray receiving surface facing the stack holder.

11. The apparatus of claim 8, wherein the drive system comprises a toothed belt and a plurality of rollers, the plurality of rollers comprising at least one drive roller and at least one idler roller, the rollers comprising splines that mesh with the toothed belt to generate rotation of the suction elements attached to the drive system.

12. The apparatus of claim 11, wherein the drive system is configured to advances each suction element from a first position to a second position by rotating 90° to a vertical position in which a tray is maintained via suction air; and advance the suction element an additional 90° to a third position wherein the tray is in the inverted direction opposite that of first position.

13. The apparatus of claim 12, wherein the suction element with the tray, when disposed at the third position, is controllable to release the tray by removing air flow that creates the Bernoulli suction effect.

14. The apparatus of claim 11, wherein the drive system is configured to move each suction element of the inverter unit in sequence through 90° of rotation at each of four positions, wherein the suction element is configured to:
at a first position, pick a tray from the stack holder;
at a second position, maintain the tray in a vertical position; and
at a third position release the inverted tray.

15. The apparatus of claim 4, wherein the first pair of cylinders is pneumatically operated.

16. The apparatus of claim 5, wherein the second pair of cylinders is pneumatically operated.

17. An apparatus for inverting trays for positioning onto a conveyor comprising:
at least one suction element; and
a drive system configured to position the at least one suction element below the tray denester system and to receive the bottom tray released from the tray denester and rotate the received tray to an inverted position, and release the received tray in an inverted position to a conveyor in a face up alignment.

18. The apparatus of claim 17, wherein the drive system is further configured to release the received tray in an inverted position to a conveyor in a face up alignment.

19. A tray handling system comprising:
a tray denester system, a rotary inverter and a conveyor; the tray denester system positioned above the rotary inverter for iteratively discharging a single tray from a nested stack of trays; the rotary inverter positioned to receive the single tray, invert the single tray and discharge the single tray to the conveyor, the rotary inverter positioned above the conveyor;
the tray denester system including a stack holder for holding at least one nested stack of trays, the stack holder comprising a column wherein the stack holder maintains the nested stack of trays in a face down alignment and biased towards a bottom end of the column; a plurality of separation elements disposed adjacent a bottom end of the stack holder, the separation elements operable to separate a bottom tray from the nested stack of trays; a plurality of pins disposed beneath the bottom tray, the pins operable to controllably release the bottom tray; and
the rotary inverter unit disposed below the tray denester system, the rotary inverter unit comprising:
at least one suction element;
and a drive system configured to position the at least one suction element below the tray denester system and to receive the bottom tray released from the tray denester and rotate the received tray to an inverted position, and release the received tray in an inverted position to the conveyor in a face up alignment;
the conveyor operable to receive a plurality of the received trays one at a time and transport the received tray away from the rotary inverter.
